(19) United States
(12) Patent Application Publication
(10) Pub. No.: US 2002/0185865 A1
(43) Pub. Date: Dec. 12, 2002

(54) Distributor for dosing a flowable material

(76) Inventors: Werner Steffan, Eichenbuhl (DE); Peter Hagmann, Erlenbach am Main (DE); Renata Schroter, Lower Hutt (NZ)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 10/127,736

(22) Filed: Apr. 22, 2002

(30) Foreign Application Priority Data
Apr. 24, 2001 (DE) 201 07 044.8

(51) Int. Cl. F16L 39/00

(52) U.S. Cl. 285/131.1; 285/125.1

(57) ABSTRACT

The invention is concerned with the problem of reducing the number of dosing pumps required for dosing a flowable polymerization material into a mould, whilst simultaneously optimizing the dosing process. By using a Y-shaped intermediate piece, the polymerization material provided by the dosing pumps can be distributed to two female mould halves, so that the number of dosing pumps can be halved. In addition, the Y-shaped construction ensures that the accuracy of dosing to the two mould halves is maintained and there is no over-dosing or under-dosing.

The invention relates to a distributor for dosing a flowable material, especially for dosing a polymerisation material for contact lenses.

Contact lenses, which are to be manufactured economically in large unit numbers, are preferably manufactured by the so-called mould or full-mould process. In these processes, the lenses are manufactured into their final shape between two mould halves, so that there is no need to subsequently finish the surfaces of the lenses, nor to finish the edges. Mould processes are described for example in PCT patent application WO 87/04390 or in EP-A 0 367 513.

In these known mould processes, the geometry of the contact lens to be manufactured is defined by the mould cavity. The edge of the contact lens is likewise formed by the mould which normally consists of two mould halves. The geometry of the edge is defined by the contour of the two mould halves in the area in which they make contact. The contact lenses produced in this manner are moulded parts having little mechanical stability and a water content of more than 60% by weight. After manufacture, the lens is checked using measuring techniques, then packaged and subjected to heat sterilisation at 121° C. in an autoclave.

To manufacture a contact lens, first of all a certain amount of the flowable starting material is placed in the female mould half. Afterwards, the mould is closed by placing the male mould half thereon. Normally, a surplus of starting material is used, so that, when the mould is closed, the excess is expelled into an overflow area adjacent to the outer mould cavity. The subsequent polymerisation or crosslinking of the starting material takes place by radiation with UV light, or by heat action, or by another non-thermal method.

In U.S. Pat. No. 5,508,317, a new contact lens material is described, which is an important improvement in the chemistry of polymerisable starting materials for the manufacture of contact lenses. The patent discloses a water-soluble composition of a prepolymer, which is filled into the mould cavity and then crosslinked photochemically. Since the prepolymer has several crosslinkable groups, crosslinking is of particularly high quality, so that a finished lens of optical quality can be produced within a few seconds, without the necessity for subsequent extraction or finishing steps. Owing to the improved chemistry of the starting material as illustrated in the patent, contact lenses can be produced at considerably lower cost, so that in this way it is possible to produce disposable lenses.

The polymerisation material is flowable and is found in containers to which excess pressure has been applied. A flexible hose is inserted into the containers and transports the material to the dispensing pumps via a delivery system. Previously, one dosing pump was provided for each female mould half, whereby a pack of, for example, 10 moulds was assembled on one tool holder and passed through the production line. However, this is linked with substantial investment costs and requires high maintenance and repair expense. In addition, considerable space is required to accommodate the pumps.

The invention is concerned with the problem of reducing the number of dosing pumps, whilst simultaneously optimising the dosing process.

The invention solves this problem with the features indicated in claim 1. As far as further essential refinements are concerned, reference is made to the dependent claims.

By using a Y-shaped intermediate piece, the polymerisation material provided by the dosing pumps can be distributed simultaneously to two female mould halves, so that the number of dosing pumps can be halved. In addition, the Y-shaped construction ensures that the accuracy of dosing to the two mould halves is maintained and there is no over-dosing or under-dosing:

Further details and advantages of the invention may be seen from the following description and the drawing. In the drawing,

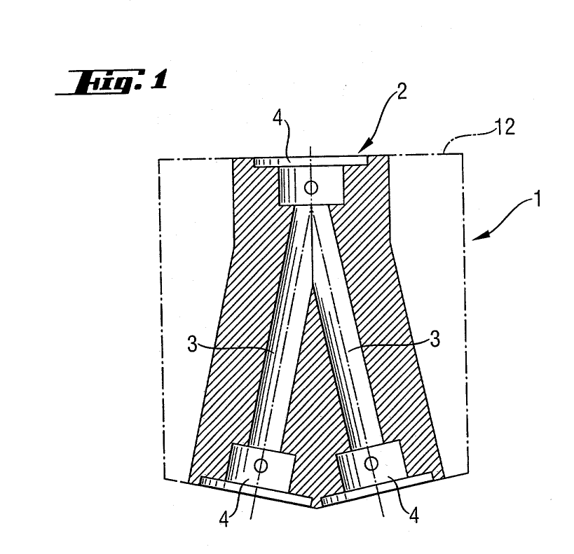

FIG. 1 shows a section through a distributor according to the invention;

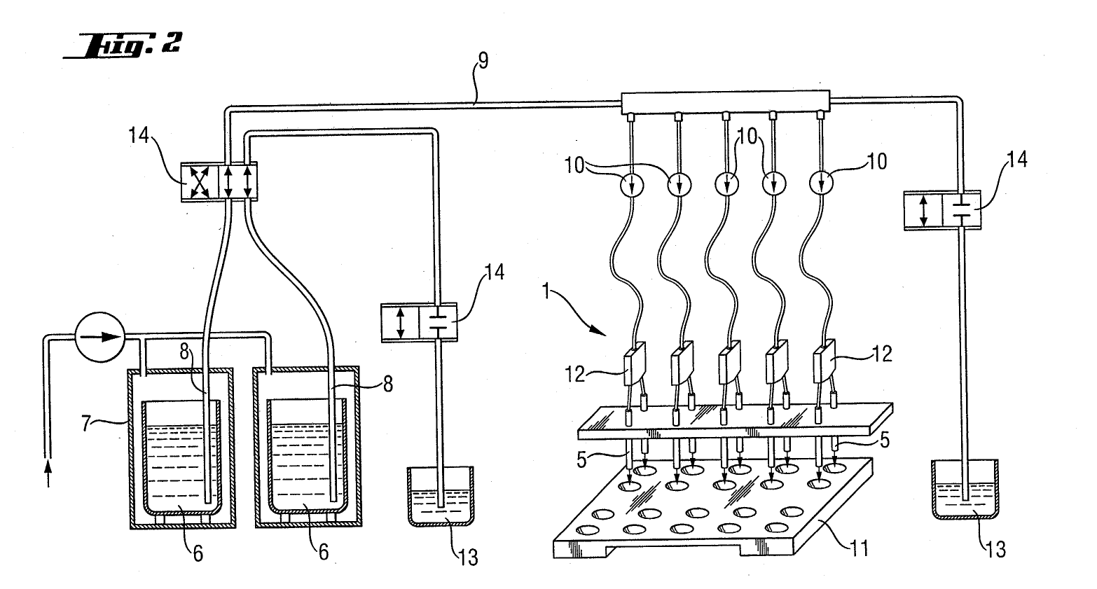

FIG. 2 shows a schematic illustration of how the polymerisation material is dosed into female mould halves.

A distributor 1 illustrated in FIG. 1 is Y-shaped and consists of an input region 2, from which two part pieces 3 emerge at an angle to one another. At their end region, these part pieces 3 are provided with a connection element 4, to which a dosing needle 5 is connected. There is preferably an angle α of 24° between the two part pieces 3 for ensuring high dosing accuracy. This angle is dependent on the viscosity of the polymerisation material to be dosed. If too great an angle is chosen, the uniformity of dosing to the two mould halves cannot be assured. The two part pieces 3 are suitably of cylindrical shape, whereby they converge in the upper region facing the input region 2. The input region 2 is likewise equipped with a connection element 4.

FIG. 2 shows a schematic illustration of the whole dosing operation. The polymerisation material is stored in containers 6, which are in turn surrounded by an outer container 7, which is connected to a nitrogen supply, so that compressed air can be applied to the containers 6. The outer container 7 has an aperture to receive a removal device 8, which is formed, for example, as a flexible hose. The removal device 8 is connected to a delivery system 9, which feeds the polymerisation material to the dosing pumps 10. The dosing pumps 10 are set so that they provide the required amount of lens material, whereby according to the invention, one dosing pump 10 provides double the amount, since this volume passes through the distributor 1 and is then distributed into two female mould halves 11. The polymerisation material is then dosed into the female mould halves through the dosing needles 5. A distributor 1 is suitably enclosed by a housing 12, in order to protect the distributor 1 from damage and to simplify handling. Preferably, two containers 6 are provided, in order to enable an automatic change of removal of the polymerisation material if a container has been emptied. In addition, a waste container 13 is advantageously provided for excess lens material from the second provided container, as well as valves 14 for regulating the required amount of material.

Over all, the invention enables the number of required dosing pumps to be halved. In addition, the Y-shaped construction ensures that the accuracy of dosing to the two mould halves is maintained and there is no over-dosing or under-dosing.

1. Distributor for dosing a flowable material into a mould half, especially in the production of contact lenses, characterised by an input region (2) and two part pieces (3) arranged at an angle to one another, which are connected to the input region (2) and are each equipped with connection elements (4).

2. Distributor according to claim 1, characterised in that the angle α between the two part pieces (3) lies in the range of 10° to 90°.

3. Distributor according to claim 2, characterised in that the angle is 24°.

4. Distributor according to one or more of claims 1 to 3, in which the input region (2) is equipped with connection elements (4).
